(19) United States
(12) Patent Application Publication
(10) Pub. No.: US 2007/0042133 A1
(43) Pub. Date: Feb. 22, 2007

(54) Visual changing ornament

(76) Inventor: Yi-Ching Needham, Jhonghe City (TW)

Correspondence Address: TROXELL LAW OFFICE PLLC, 5205 LEESBURG PIKE, SUITE 1404, FALLS CHURCH, VA, 22041, US

(21) Appl. No.: 11/205,092

(22) Filed: Aug. 17, 2005

(51) Int. Cl. C09K 19/00

(52) U.S. Cl. 428/1.1

(57) ABSTRACT

The present invention provides a visual changing ornament structure, wherein one layer of a chemical raw material layer filled with chemical agents is disposed between a shell and a protective film. A property of the chemical agents enables morphological physical changes produced in the chemical agents to transform the original morphological appearance of the chemical agents, thereby imparting a change in visual impact to the ornament structure. Changing the chemical agents within the chemical raw material layer to ones having different properties enables producing alternative visual changes.

### BACKGROUND OF THE INVENTION

(a) Field of the Invention

The present invention relates to a visual changing ornament structure, and more particularly to an ornament structure that includes one layer of a chemical raw material filled with a chemical agent that is adhered to and covers a surface of a shell.

(b) Description of the Prior Art

A conventional shell ornament structure includes coloration of a shell, which provides the shell ornament with an attractive effect. However, because color collocation displayed by the coloration is formed by mixing a number of fundamental colors, thus, the shell ornament is only able to provide a visual effect of brilliant colors, and the monotonous non-variability of the shell ornament often makes people neglect the distinguishing features and appreciative value of the ornament.

Furthermore, the chemical agents added to conventional ornaments to produce a visual change effect can only be used in materials such as metals, glass, plastic, and so on, whereas application in shell ornaments is difficult.

Hence, the inventor of the present invention proposes to resolve and surmount existent technical difficulties to eliminate the aforementioned shortcomings in prior art.

### SUMMARY OF THE INVENTION

The present invention provides a visual changing ornament structure, wherein one layer of a chemical raw material layer filled with chemical agents is disposed between a shell and a protective film. A property of the chemical agents enables morphological physical changes produced in the chemical agents to transform the original morphological appearance of the chemical agents, thereby imparting a change in visual impact to the ornament structure. A protective film further covers a surface of the chemical raw material layer, and is used to prevent the chemical agents within the chemical raw material layer from being exposed and coming in contact with air.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an elevational view according to the present invention.

FIG. 2 shows an exploded elevational view according to the present invention.

FIG. 3 shows a schematic view depicting an embodiment of the present invention in use (1).

FIG. 4 shows a schematic view depicting the embodiment of the present invention in use (2).

FIG. 5 shows a schematic view depicting another embodiment of the present invention in use (3).

FIG. 6 shows a schematic view depicting the embodiment of the present invention in use (4).

### DETAILED DESCRIPTION OF THE PREFERRED EMBODIMENTS

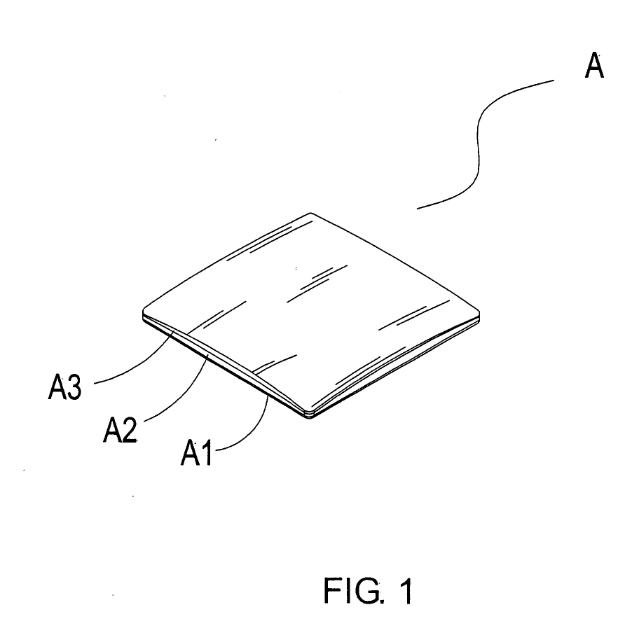

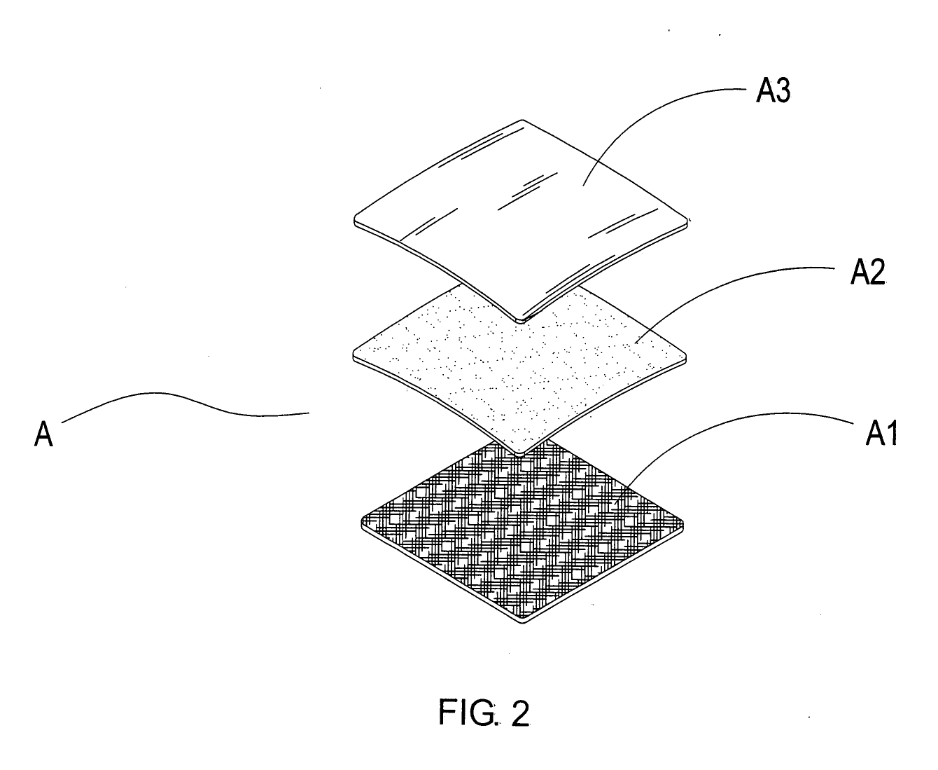

Referring to FIGS. 1 and 2, which show a visual changing ornament structure of the present invention, wherein a main body A is structured to comprise a shell A1, a chemical raw material layer A2 and a protective film A3.

One layer of the chemical raw material layer A2 filled with chemical agents is adhered to and covers one side of the shell A1, and the protective film A3 further covers a surface of the chemical raw material layer A2, thereby sandwiching the chemical raw material layer A2 between the protective film A3 and the shell A1. The protective film A2 prevents the chemical agents within the chemical raw material layer A2 covered therewith from being exposed and coming in contact with air, and morphological physical changes produced in the chemidal agents within the chemical raw material layer A2 further transform the original morphological appearance of the chemical agents, which impart a change in visual impact to the main body A.

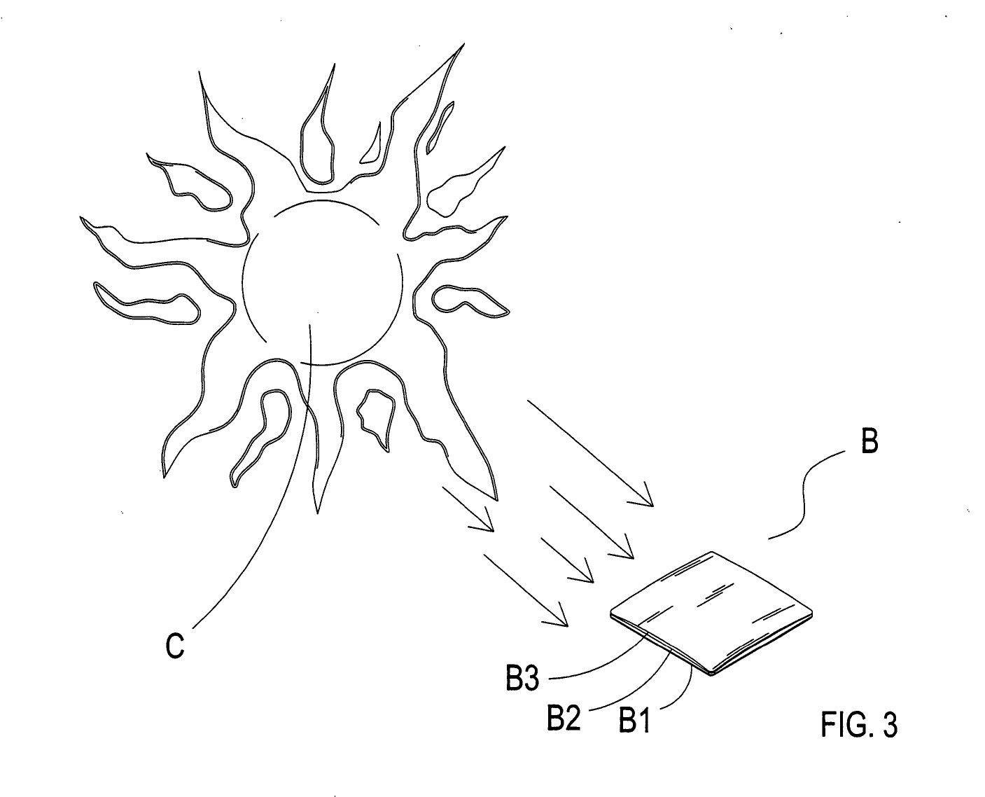

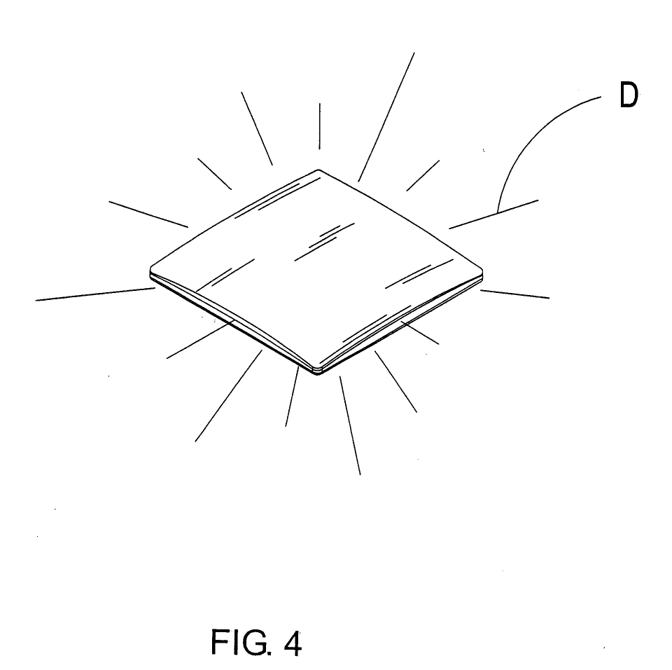

Referring to FIGS. 3 and 4, which show an embodiment of the present invention in use, wherein a chemical raw material layer B2 sandwiched between a shell B1 and a protective cover B3 of a main body B is filled with a chemical agent having photosensitive variation property. When the main body B is placed in a location irradiated with a light source C, because the light source C causes the photosensitive variation property of the chemical agent to produce a physical change in morphology that transforms the original appearance of the chemical agent, thus, a transformation in the original color and luster of the chemical agent is realized, which produces an alternative visual color change effect. Furthermore, after the chemical agent having a photosensitive variation property has been irradiated by the light source C, thereby producing a physical change in morphology in the chemical agent, if the shell B is moved to a dark location, the physical change in morphology of the chemical agent assumes a light emitting D state. Hence, the shell B is able to produce a visual change effect when placed in a light or dark location.

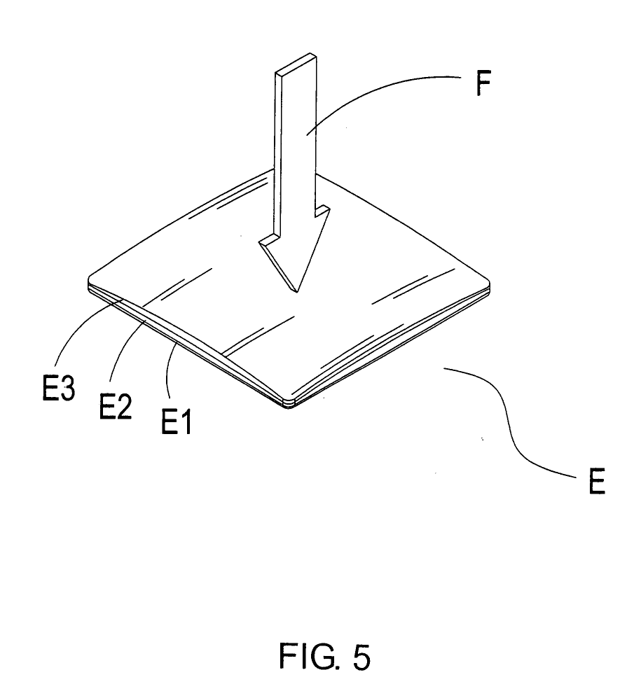

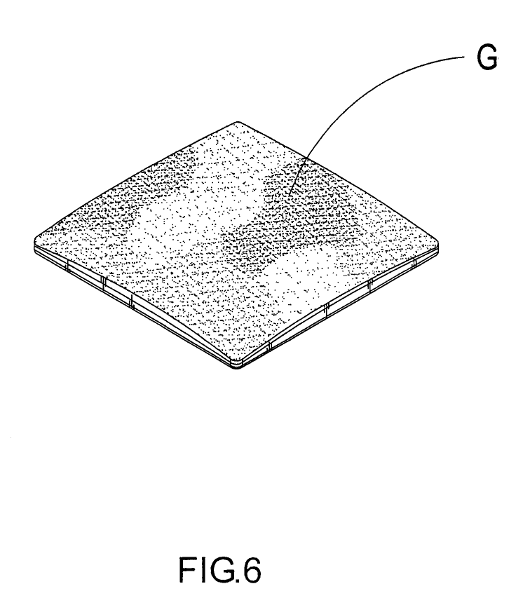

Referring to FIGS. 5 and 6, wherein a chemical raw material layer E2 sandwiched between a shell E1 and a protective cover E3 of a main body E is filled with a chemical agent having a temperature variation property. When the main body E is placed in a situation where it undergoes heating F, the temperature variation property of the chemical agent within the chemical raw material layer E2 produces a morphological physical change in the chemical agent, which further transforms the appearance of the original chemical agent. The physical change produced in the chemical agent causes a transformation in color and luster thereof as the temperature varies. Hence, when under circumstances whereby the main body E undergoes temperature variation, the color and luster of the chemical agent is transformed, and produces a visual effect that displays coloration changes in a top layer G as the temperature varies.

In order to better explicitly disclose advancement and practicability of the present invention, a comparison with conventional art is described hereinafter:

Shortcomings of Prior Art:

1. Color of a conventional shell is of fixed appearance, and is thus unable to impart a change in visual impact to the shell.

2. The conventional shell has a monotonous visual effect, Which is unable to display the distinguishing features of the shell ornament.

Advantages of the Present Invention:

1. One layer of the chemical raw material layer (A2, B2, E2) is adhered to an upper surface of the shell (A1, B1, E1), and a physical change in morphology produced in the chemical agent within the chemical raw material layer (A2, B2, E2) realizes a visual change effect.

2. Changing the chemical agent within the chemical raw material layer (A2, B2, E2) on (A1, B1, E1) the shell enables producing an alternative visual change.

3. The present invention is better able to display more prominently the distinguishing features of the shell ornament.

4. Provided with practicability and advancement.

5. Enhances commercial competitiveness.

In conclusion, the present invention in overcoming structural shortcomings of prior art has assuredly achieved effectiveness of anticipated advancement, and, moreover, is easily understood by persons unfamiliar with related art. Furthermore, contents of the present invention have not been publicly disclosed prior to this application, and practicability and advancement of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A visual changing ornament structure comprising the layer of a chemical raw material layer that is adhered to and covers one side of a surface of a shell, and a protective film that further covers a surface of the chemical raw material layer to protect it, thereby forming an integral body; the visual changing ornament structure is characterized in that morphological physical changes produced in chemical agents filled within the chemical raw material layer adhered to and covering the shell further transform the original morphological appearance of the chemical agents, which impart a change in visual impact to the ornament structure, furthermore, the protective film prevents the chemical agents within the chemical raw material layer from being exposed and coming in contact with air, which would otherwise result in oxidization and deterioration of the chemical agents within the chemical raw material layer.

2. The visual changing ornament structure according to claim 1, wherein the chemical agents within the chemical raw material layer are color variable materials including luminous chemicals, photochromic materials and microcapsule liquid crystals, and the three types of color variable materials can be used alone or mixed to form a composition thereof.
